(19) United States
(12) Patent Application Publication
(10) Pub. No.: US 2015/0052621 A1
(43) Pub. Date: Feb. 19, 2015

(54) MEDIA CONTENT STREAMING SERVICE

(71) Applicant: KT Corporation, Seongnam-si (KR)

(72) Inventor: Donghoon YI, Gapyeong-gun (KR)

(21) Appl. No.: 14/457,452

(22) Filed: Aug. 12, 2014

(30) Foreign Application Priority Data
Aug. 14, 2013 (KR) 10-2013-0096750

(51) Int. Cl. H04L 29/06; H04L 29/08; G06F 21/10

(52) U.S. Cl. CPC H04L 65/60; H04L 63/20; G06F 21/105; H04L 67/18
USPC 726/31; 709/219; 726/27

(57) ABSTRACT

In one example embodiment, a server includes a receiver configured to receive, from a first device having rights to use or play first media content, characteristics of the first device or a user of the first device; a group manager configured to add the first device into a content sharing group having a second device, based on the characteristics of the first device or the user of the first device; a content list manager configured to transmit, to the first device, a group content list that includes second media content that the second device has rights to play; and a streaming transmitter configured to stream the second media content to the first device.

### TECHNICAL FIELD

The embodiments described herein pertain generally to a media content streaming service.

### BACKGROUND

Streaming of media content (e.g., video or audio content) over wide area networks (e.g., the Internet, a carrier-specific network, etc.) is a growing industry fueled at least in part by advances in high-bandwidth network infrastructures.

### SUMMARY

In one example embodiment, a server may include a receiver configured to receive, from a first device having rights to use or play first media content, characteristics of the first device or a user of the first device; a group manager configured to add the first device into a content sharing group having a second device, based on the characteristics of the first device or the user of the first device; a content list manager configured to transmit, to the first device, a group content list that includes second media content that the second device has rights to play; and a streaming transmitter configured to stream the second media content to the first device.

In another example embodiment, a method performed under control of a server may include: receiving, from a first device having rights to play first media content, characteristics of the first device or a user of the first device; adding the first device into a content sharing group having a second device, based on the characteristics of the first device or the user of the first device; transmitting, to the first device, a group content list that includes second media content that the second device has rights to play; and streaming the second media content to the first device.

In yet another example embodiment, a computer-readable storage medium may store thereon computer-executable instructions that, in response to execution, cause a server to perform operations including: receiving, from a first device having rights to play first media content, characteristics of the first device or a user of the first device; adding the first device into a content sharing group having a second device, based on the characteristics of the first device or the user of the first device; transmitting, to the first device, a group content list that includes second media content that the second device has rights to play; and streaming the second media content to the first device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which a media content streaming service may be implemented, in accordance with various embodiments described herein;

FIG. 2A shows an illustrative example content sharing group by which at least portions of a media content streaming service may be implemented, in accordance with various embodiments described herein;

FIG. 2B shows another illustrative example content sharing group by which at least portions of a media content streaming service may be implemented, in accordance with various embodiments described herein;

FIG. 3 shows an illustrative example device by which at least portions of a media content streaming service may be implemented, in accordance with various embodiments described herein;

FIG. 4 shows another illustrative example device by which at least portions of a media content streaming service may be implemented, in accordance with various embodiments described herein;

FIG. 5 shows another illustrative example device by which at least portions of a media content streaming service may be implemented, in accordance with various embodiments described herein;

FIG. 6 shows an example server by which at least portions of a media content streaming service may be implemented, in accordance with various embodiments described herein;

FIG. 7 shows an example processing flow of operations by which at least portions of a media content streaming service may be implemented, in accordance with various embodiments described herein; and

FIG. 8 shows an illustrative computing embodiment, in which any of the processes and sub-processes of a media content streaming service may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

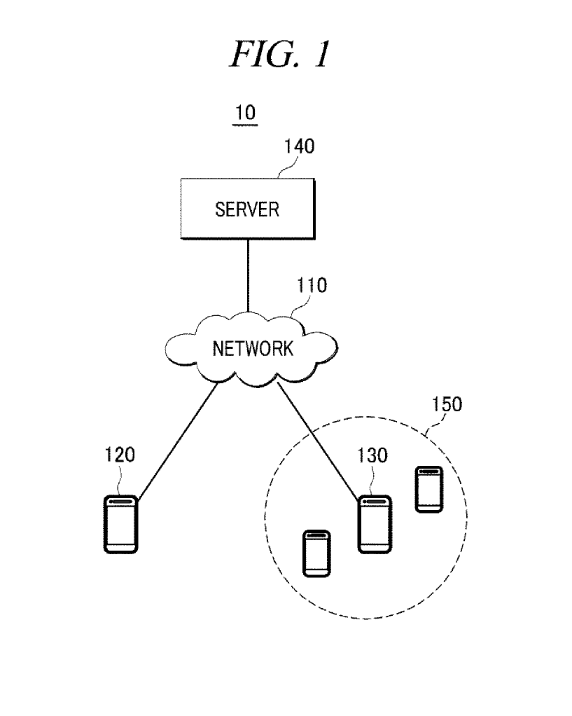

FIG. 1 shows an example system 10 in which a media content streaming service may be implemented, in accordance with various embodiments described herein. As depicted in FIG. 1, system 10 may include, at least, a first device 120, a second device 130, and a server 140. At least two or more embodiments of first device 120, second device 130, and server 140, respectively, may be communicatively connected to each other via a network 110. Unless context requires otherwise, collective reference may be made to first devices 120, second devices 130, and/or servers 140; and representative reference may be made to first device 120, second device 130, and/or server 140.

Network 110 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro (Wireless Broadband Internet), Mobile WiMAX, HSDPA (High Speed Downlink Packet Access), Bluetooth, or the like.

Respective ones of first device 120 and second device 130, as non-limiting examples, may refer to a notebook computer, a personal computer, a smart phone, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

Server 140 may refer to one or more apparatuses or servers hosted and/or supported by a service provider that provides media content streaming services to multiple end devices including the one or more embodiments of, respectively, first device 120 and second device 130. Server 140 may be one of multiple hosted servers or other processing apparatuses that may be configured to manage and/or facilitate organization of a content sharing group that includes multiple end devices; to generate and update a group content list associated with the content sharing group; and to stream media content included in the group content list to the end devices included in the content sharing group. So the end devices may share with each other media content to which a user account authenticated on respective end devices has user rights.

In some embodiments, server 140 may be configured to receive, from first device 120, a request to share first media content with other end devices (e.g., second device 130). A user account authenticated on first device 120 may have user rights to the first media content. For example, but not as a limitation, the first media content may include at least one of video content, audio content or eBook content. Further, for example, user rights to the first media content may refer to authorization to access, use, play, reproduce, listen, read and/or download the first media content.

Further, server 140 may be configured to receive, from first device 120 along with the request, characteristics of first device 120 or a user of first device 120. For example, but not as a limitation, the characteristics of first device 120 or the user of first device 120 may include at least one of location information of first device 120, individual information regarding age or gender of the user of first device 120, or identification information of first device 120. Further, the location information of first device 120 may include at least one of location coordinates provided by a global positioning system (GPS) sensor communicatively coupled to first device 120, base station information regarding a base station communicatively coupled to first device 120, or access point information regarding an access point communicatively coupled to first device 120.

Further, server 140 may be configured to add first device 120 into a content sharing group 150 that has at least one end device including second device 130, based on the received characteristics of first device 120 and/or the user of first device 120.

In some embodiments, server 140 may be configured to calculate a distance between a present location of first device 120 and a present location of second device 130 included in content sharing group 150, based on the location coordinates of first device 120 and second device 130. Further, server 140 may be configured to add first device 120 into content sharing group 150, if the calculated distance is less than a threshold distance value stored in a memory of server 140. Server 140 may be configured to add, in content sharing group 150, first device 120 that is located within a predetermined range (e.g., the threshold distance value) from second device 130 to thereby organize content sharing group 150 that includes both of first device 120 and second device 130. The threshold distance value may be predefined or preregistered by an operator or an entity that owns or controls server 140.

In some embodiments, server 140 may be configured to manage and/or organize content sharing group 150 that includes first device 120 and second device 130 based on the age or gender of the user of first device 120 and that of a user of second device 130. For example, but not as a limitation, server 140 may be configured to add first device 120 into content sharing group 150 that has already included second device 130, if age or gender of the user of first device 120 is the same as that of the user of second device 130. As another example, server 140 may be configured to add first device 120 into content sharing group 150 that has already included second device 130, if the age of the user of first device 120 and the age of the user of second device 130 are affiliated to a same age group (e.g., in teens).

In some embodiments, server 140 may be configured to add first device 120 into content sharing group 150 if the identification information (e.g., an identifier) assigned to a user account authenticated on first device 120 has been previously registered with content sharing group 150 by second device 130.

In some embodiments, server 140 may be configured to receive, from first device 120, the characteristics of first device 120 that include a user input to select content sharing group 150, and authentication information associated with content sharing group 150. The user input may include a request to join content sharing group 150. For example, but not as a limitation, the authentication information associated with content sharing group 150 may refer to a login identifier and/or a password to enter content sharing group 150. Server 140 may be further configured to add first device 120 into content sharing group 150, based on the user input to select content sharing group 150 and the authentication information associated with content sharing group 150.

Server 140 may be configured to generate and/or update a group content list to include, at least, the first media content and second media content. The user account authenticated on first device 120 has user rights to the first media content, and a user account authenticated on second device 130 has user rights to the second media content. For example, but not as a limitation, the second media content may include at least one of video content, audio content or eBook content. In some embodiments, server 140 may be configured to have and/or store content information (e.g., name, author, playable number, playable period, etc.) regarding media content to which each user account authenticated on each device including the one or more embodiments of, respectively, first device 120 and second device 130 has user rights, in association with identification information of each of the device including the one or more embodiments of, respectively, first device 120 and second device 130. Server 140 may be further configured to identify the first media content to which the user account authenticated on first device 120 has user rights, based on the identification information of first device 120. Further, server 140 may be configured to add the first media content into a group content list that already included the second media content to which the user account authenticated on second device 130, which is included in content sharing group 150, has user rights.

In some embodiments, server 140 may be configured to receive, from first device 120, content information regarding the first media content (e.g., name, author, playable number, playable period, etc.). Server 140 may be further configured to update the group content list that already included the second media content to thereby include the first media content, based on the received content information regarding the first media content.

In some embodiments, server 140 may be configured to update the group content list that included the first media content and the second media content to thereby exclude the first media content, when server 140 withdraws first device 120 from content sharing group 150.

In some embodiments, server 140 may be configured to receive the characteristics of first device 120 or the user of first device 120 at a predetermined time interval. For example, server 140 may be configured to request for first device 120 to transmit the characteristics of first device 120 or the user of first device 120 at every one minute, and to receive them at every one minute. Further, server 140 may be configured to withdraw first device 120 from content sharing group 150 if a factor that withdraws first device 120 from content sharing group 150 occurs with regard to the characteristics. For example, if a distance between the present location of first device 120 and the present location of second device 130 included in content sharing group 150 becomes greater than the threshold distance value, server 140 may withdraw first device 120 from content sharing group 150. Server 140 may be configured to then update the group content list that included the first media content and the second media content to thereby exclude the first media content. Further, in some embodiments, server 140 may be configured to then update the group content list that included the first media content and the second media content to thereby exclude the second media content, when server 140 withdraws second device 130 from content sharing group 150.

Further, server 140 may be configured to transmit, to first device 120 and second device 130 included in content sharing group 150, the updated group content list that has the first media content and the second media content. Further, in some embodiments, server 140 may be configured to transmit, to second device 130, the group content list that was updated to exclude the first media content, when server 140 withdraws first device 120 from content sharing group 150. Further, in some embodiments, server 140 may be configured to transmit, to first device 120, the group content list that was updated to exclude the second media content, when server 140 withdraws second device 130 from content sharing group 150.

Further, server 140 may be configured to stream the second media content to first device 120 included in content sharing group 150. In some embodiments, server 140 may be configured to receive, from first device 120, a user input to select the second media content that a user account authenticated on second device 130 has user rights from the group content list. Further, server 140 may be configured to stream the second media content to first device 120, based on the received input.

Further, server 140 may be configured to stream the second media content to first device 120 in parallel with streaming of the second media content to second device 130, while server 140 streams the second media content to second device 130. For example, server 140 may be configured to stream the second media content (e.g., second music) to first device 120 starting or resuming from the same play time point of the second media content being streamed to second device 130. So, the same part of the second media content may be streamed to first device 120 and second device 130, simultaneously. Thus, a user of first device 120 and a user of second device 130 may share the second media content (e.g., second music) as if they are listening to the second music together via a speaker in a room or via a same ear phone.

In some embodiments, server 140 may be configured to store authorization information for playing the second media content to which the user account authenticated on second device 130 included in content sharing group 150. For example, but not as a limitation, the authorization information may include at least one of a number of authorized plays for the second media content or an authorized period of time in which the second media content may be played by second device 130 or other devices. Further, server 140 may be configured to stream the second media content to first device 120, based on the authorization information.

In some embodiments, server 140 may be configured to stream the first media content to second device 130, which is included in content sharing group 150. Server 140 may be configured to receive, from second device 130, a user input to select, from the group content list, the first media content to which the user account authenticated on first device 120 has user rights. Further, server 140 may be configured to stream the first media content to second device 130, based on the received user input. Further, server 140 may be configured to stream the first media content to second device 130 in parallel with streaming of the first media content to first device 120, while server 140 streams the first media content to first device 120.

In some embodiments, server 140 may be configured to receive, from first device 120, authorization information for playing the first media content. For example, but not as a limitation, the authorization information may include at least one of a number of authorized plays for the first media content or an authorized period of time in which the first media content may be played. Further, server 140 may be configured to stream the first media content to second device 130, based on the received authorization information.

In some embodiments, server 140 may be configured to stop streaming of the first media content to second device 130 when server 140 withdraws first device 120 from content sharing group 150. Further, server 140 may be configured to stop streaming of the second media content to first device 120 if server 140 withdraws second device 130 from content sharing group 150.

In some embodiments, server 140 may be configured to continue streaming of the first media content to second device 130 after server 140 withdraws first device 120 from content sharing group 150. For example, but not as a limitation, when server 140 withdraws first device 120 from content sharing group 150 while streaming the first media content to second device 130, server 140 may be configured to continue streaming of the first media content to second device 130 for a predetermined time thereafter. Thus, a user of second device 130 may seamlessly view or listen to the first media content, to which the user account authenticated on first device 120 has user rights. Further, server 140 may be configured to continue streaming of the second media content to first device 120 after server 140 withdraws second device 130 from content sharing group 150.

Thus, FIG. 1 shows an example system 10 in which a media content streaming service may be implemented, in accordance with various embodiments described herein.

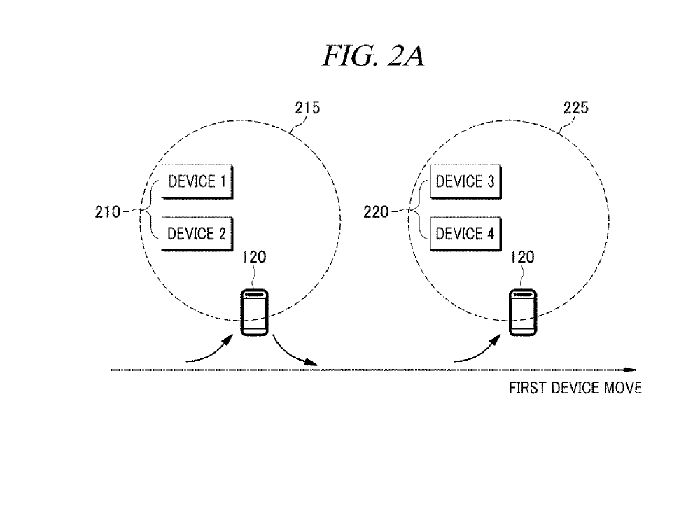

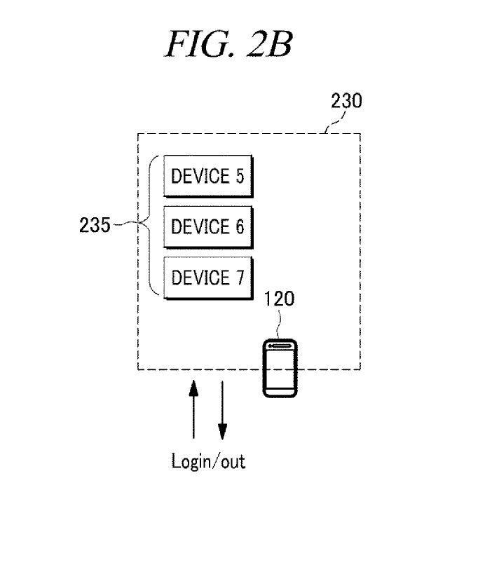

FIG. 2A shows an illustrative example content sharing group by which at least portions of a media content streaming service may be implemented, in accordance with various embodiments described herein. In some embodiments, server 140 may be configured to receive, from first device 120, location information of first device 120. Further, server 140 may be configured to calculate a distance between a present location of first device 120 and a present location of other devices included in a content sharing group. Further, server 140 may be configured to add first device 120 into the content sharing group, if the calculated distance is less than a threshold distance value stored in server 140. Server 140 may be configured to add, in the content sharing group, first device 120 that is located within a predetermined range (e.g., the threshold distance value) from the other devices included in the content sharing group.

For example, as depicted in FIG. 2A, if first device 120 moves to within a threshold distance of other devices 210 (e.g., device 1 and device 2), server 140 may be configured to add first device 120 into a first content sharing group 215 that includes other devices 210 (e.g., device 1 and device 2). Further, server 140 may be configured to update a first group content list to include first media content to which a user account authenticated on first device 120 has user rights. Thus, the first group content list may have the first media content in addition to other media content, to which user accounts authenticated on other devices 210 have user rights. Further, server 140 may be configured to transmit the first group content list to first device 120 and other devices 210 that are included in first content sharing group 215. Further, server 140 may be configured to stream the first media content to other devices 210, and to stream the other media content to first device 120. Alternatively, server 140 may be configured to stream the first media content to other devices 210 in parallel with streaming to first device 120.

Further, if first device 120 moves away from other devices 210 and if the distance between first device 120 and other devices 210 becomes greater than the threshold distance value, server 140 may be configured to withdraw first device 120 from first content sharing group 215. Further, server 140 may be configured to stop streaming of the first media content to other devices 210, and to stop streaming of the other media content to first device 120. Further, server 140 may be configured to update the first group content list to thereby exclude the first media content, and to transmit the updated first group content list to other devices 210.

Further, if first device 120 moves to within a range of a threshold distance to other devices 220 (e.g., device 3 and device 4), server 140 may be configured to add first device 120 into a second content sharing group 225 that includes other devices 220 (e.g., device 3 and device 4). Further, server 140 may be configured to generate and update a second group content list that already includes other media content, to which user accounts authenticated on other devices 220 have user rights to thereby include the first media content. Further, server 140 may be configured to transmit the second group content list to first device 120 and other devices 220 that are included in second content sharing group 225. Further, server 140 may be configured to stream the first media content to other devices 220, and to stream the other media content to first device 120. Alternatively, server 140 may be configured to stream the first media content to other devices 220 in parallel with streaming to first device 120.

Thus, FIG. 2A shows an illustrative example content sharing group by which at least portions of a media content streaming service may be implemented, in accordance with various embodiments described herein.

FIG. 2B shows another illustrative example content sharing group by which at least portions of a media content streaming service may be implemented, in accordance with various embodiments described herein. In some embodiments, server 140 may be configured to receive, from first device 120, a user input to select a content sharing group 230 that includes other devices 235 and authentication information associated with content sharing group 230. The user input may include a request to join content sharing group 230. For example, the authentication information associated with content sharing group 230 may refer to at least one of a login identifier or a password for first device 120 to join content sharing group 230. Server 140 may be further configured to add first device 120 into content sharing group 230, based on the user input to select content sharing group 230 and the authentication information associated with content sharing group 230.

Further, server 140 may be configured to update a group content list to thereby include first media content, to which a user account authenticated on first device 120 has user rights, and other media content, to which user accounts respectively authenticated on other devices 235 have user rights. Further, server 140 may be configured to transmit the group content list to first device 120 and other devices 235 that are included in content sharing group 230. Further, server 140 may be configured to stream the first media content to other devices 235, and to stream the other media content to first device 120. Alternatively, server 140 may be configured to stream the first media content to other devices 235 in parallel with streaming to first device 120.

Further, if server 140 receives, from first device 120, a request to log-out from content sharing group 230, server 140 may be configured to withdraw first device 120 from content sharing group 230. Further, server 140 may be configured to stop streaming of the first media content to other devices 235, and to stop streaming of the other media content to first device 120. Further, server 140 may be configured to update the group content list to thereby exclude the first media content, and to transmit the updated group content list to other devices 235.

Thus, FIG. 2B shows another illustrative example content sharing group by which at least portions of a media content streaming service may be implemented, in accordance with various embodiments described herein.

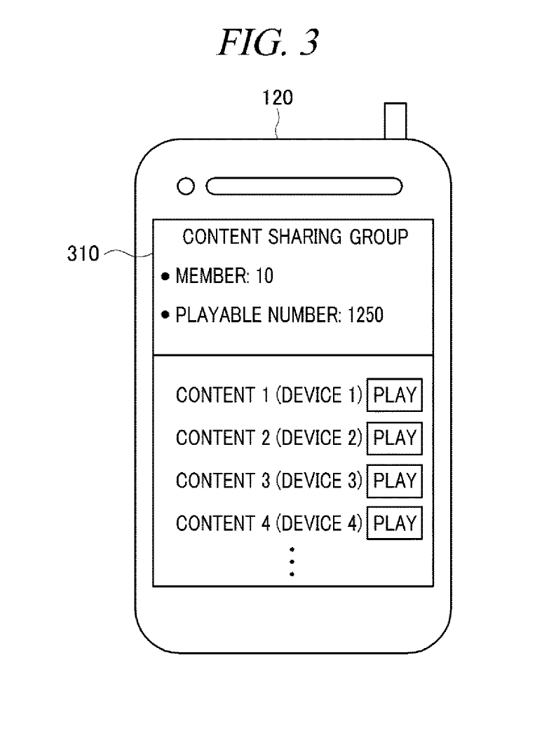

FIG. 3 shows an illustrative example device by which at least portions of a media content streaming service may be implemented, in accordance with various embodiments described herein. For example, as depicted in FIG. 3, first device 120 may be configured to display a group content list 310 on a display that may be part of, or communicatively coupled to, first device 120. For example, group content list 310 may include a name of a content sharing group associated with group content list 310, a number of devices included in the content sharing group, authorization information (e.g., playable number) to play media content included in group content list 310, etc. Further, group content list 310 may include names of respective media content in association with device names of each corresponding device that has user rights to the respective media content.

For example, if first device 120 receives a user input to select media content (e.g., “content 2”), to which a user account authenticated on a device (e.g., “device 2”) has user rights, from group content list 310, first device 120 may be configured to transmit to server 140, to a request to stream the selected media content (e.g., “content 2”). Server 140 may be configured to stream the media content (e.g., “content 2”) to first device 120 in response to the user input, while server 140 streams the media content (e.g., “content 2”) to the device (e.g., “device 2”).

Thus, FIG. 3 shows an illustrative example device by which at least portions of a media content streaming service may be implemented, in accordance with various embodiments described herein.

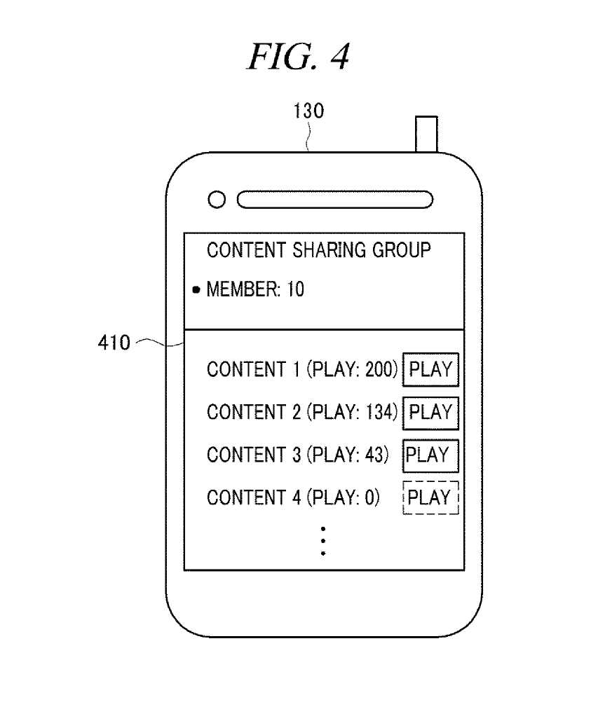

FIG. 4 shows another illustrative example device by which at least portions of a media content streaming service may be implemented, in accordance with various embodiments described herein. For example, as depicted in FIG. 4, second device 130 may be configured to display a group content list 410 on a display that may be part of, or communicatively coupled to, second device 130. For example, group content list 410 may include a name of a content sharing group associated with group content list 410 and a number of devices included in the content sharing group. Further, group content list 410 may include names of respective media content in association with authentication information (e.g., a playable number) to play each media content included in group content list 410.

In some embodiments, server 140 may be configured to stream the media content to second device 130, based on the authentication information of the media content. For example, but not as a limitation, if second device 130 receives a user input to select media content (e.g., “content 1”) that has remaining authorized plays (uses) from group content list 410, first device 120 may be configured to transmit to server 140, a request to stream the selected media content (e.g., “content 1”). Server 140 may be configured to stream the media content (e.g., “content 1”) to second device 130 in response to the user input. However, if authorized plays (uses) of the media content (e.g., “content 4”) has been exhausted, second device 130 may not be able to receive a user input to select the media content (e.g., “content 4”), and server 140 may not stream the media content (e.g., “content 4”) that has no remaining authorized plays to second device 130.

Thus, FIG. 4 shows another illustrative example device by which at least portions of a media content streaming service may be implemented, in accordance with various embodiments described herein.

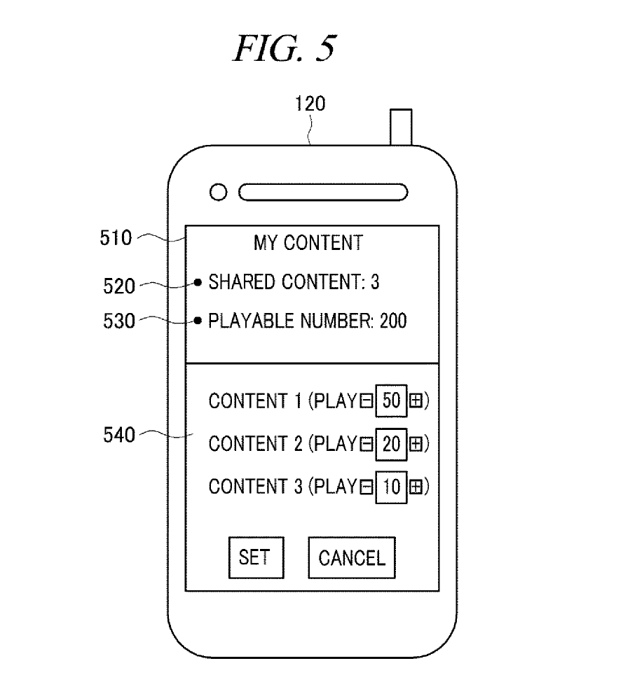

FIG. 5 shows another illustrative example device by which at least portions of a media content streaming service may be implemented, in accordance with various embodiments described herein. In some embodiments, for example, first device 120 may be configured to display a content sharing setting interface 510 on a display that may be part of, or communicatively coupled to, first device 120. For example, as depicted in FIG. 5, content sharing setting interface 510 may include a number 520 of media content to be shared or sharable with other devices and a number 530 of remaining authorized plays (uses) of media content to which a user account authenticated on first device 120 has user rights. Further, content sharing setting interface 510 may include a list 540 that includes names of media content to which the user account authenticated on first device 120 has user rights and playable numbers of each media content.

Further, first device 120 may be configured to receive a user input to set the authorized number of plays for the media content to be shared with other devices via content sharing setting interface 510. For example, if first device 120 receives a user input to set the authorized number of remaining plays of each media content as depicted in FIG. 5, first device 120 may be configured to transmit, to server 140, the received user input. Server 140 may be configured to stream each media content to which the user account authenticated on first device 120 has user rights, based on the authorized number of remaining plays of each media content. For example, server 140 may be allowed to stream the “content 1” to other devices including second device 130 up to fifty times. Further, server 140 may be allowed to stream the “content 2” to other devices including second device 130 within twenty times, and to stream the “content 3” to other devices including second device 130 up to ten times.

Thus, FIG. 5 shows another illustrative example device by which at least portions of a media content streaming service may be implemented, in accordance with various embodiments described herein.

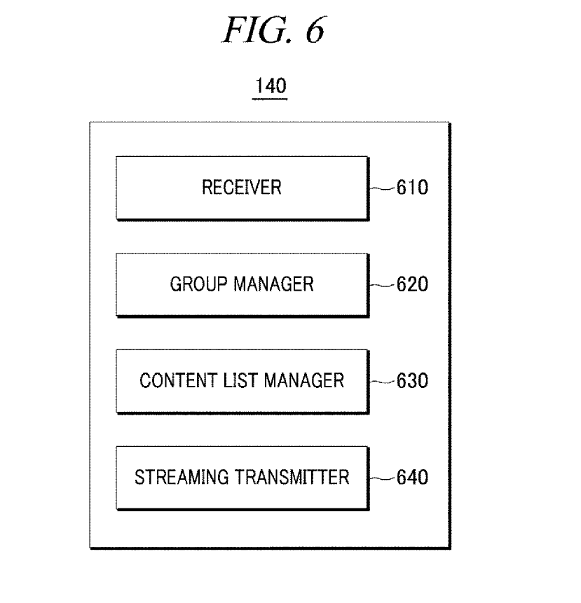

FIG. 6 shows an example server by which at least portions of a media content streaming service may be implemented, in accordance with various embodiments described herein. As depicted in FIG. 6, server 140 may include a receiver 610, a group manager 620, a content list manager 630 and a streaming transmitter 640. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 610, group manager 620, content list manager 630 and streaming transmitter 640 may be included in an instance of an application hosted on server 140.

Receiver 610 may be configured to receive, from first device 120, a request to share first media content, to which a user account authenticated on first device 120 has user rights, with other end devices (e.g., second device 130). For example, but not as a limitation, the first media content may include at least one of video content, audio content, or eBook content.

Further, receiver 610 may be configured to receive, from first device 120, characteristics of first device 120 or a user of first device 120. In some embodiments, receiver 610 may be configured to receive the characteristics of first device 120 or the user of first device 120 at a predetermined time interval (e.g., at every one minute). For example, but not as a limitation, the characteristics of first device 120 or the user of first device 120 may include at least one of location information of first device 120, individual information regarding age or gender of the user of first device 120 or identification information of first device 120. Further, the location information of first device 120 may include at least one of location coordinates provided by a GPS sensor communicatively coupled to first device 120, base station information regarding a base station communicatively coupled to first device 120, or access point information regarding an access point communicatively coupled to first device 120.

Further, in some embodiments, receiver 610 may be configured to receive, from first device 120, the characteristics of first device 120 that includes a user input to select a content sharing group and authentication information associated with the selected content sharing group. The user input may include a request to join the content sharing group. For example, the authentication information associated with the selected content sharing group may refer to a login identifier and/or a password for first device 120 to enter the content sharing group.

Further, in some embodiments, receiver 610 may be configured to receive, from first device 120, content information regarding the first media content (e.g., name, author, playable number, playable period, etc.).

Further, in some embodiments, receiver 610 may be configured to receive, from first device 120, authorization information for playing the first media content. For example, but not as a limitation, the authorization information may include at least one of a number of authorized plays for the first media content or an authorized period of time in which the first media content may be played.

Group manager 620 may be configured to add first device 120 into a content sharing group that has at least one end device including second device 130, based on the received characteristics of first device 120 and/or the user of first device 120. In some embodiments, group manager 620 may be configured to calculate a distance between a present location of first device 120 and a present location of second device 130 included in a content sharing group, based on the location coordinates of first device 120 and second device 130. Further, group manager 620 may be configured to add first device 120 into the content sharing group, if the calculated distance is less than a predetermined threshold distance value stored in a memory of server 140.

In some embodiments, group manager 620 may be configured to manage and/or organize a content sharing group that includes first device 120 and second device 130, based on the age or gender of the user of first device 120 and that of a user of second device 130. For example, group manager 620 may be configured to add first device 120 into a content sharing group that has already included second device 130, if age or gender of the user of first device 120 is the same as that of the user of second device 130. As another example, group manager 620 may be configured to add first device 120 into the content sharing group that has already included second device 130, if the age of the user of first device 120 and the age of the user of second device 130 are affiliated to a same age group (e.g., in teens).

In some embodiments, group manager 620 may be configured to add first device 120 into a content sharing group, based on the received user input that includes a request to join the content sharing group and the received authentication information associated with the selected content sharing group.

Further, group manager 620 may be configured to withdraw first device 120 from a content sharing group if a factor that withdraws first device 120 from a content sharing group occurs with regard to the characteristics of first device 120. For example, if a distance between the present location of first device 120 and the present location of second device 130 included in the content sharing group becomes greater than the threshold distance value, group manager 620 may withdraw first device 120 from the content sharing group. For another example, group manager 620 may be configured to withdraw first device 120 from the content sharing group, based on a request, which is received from first device 120, to log-out from the content sharing group.

Content list manager 630 may be configured to generate and/or update a group content list to include, at least, the first media content and second media content. The user account authenticated on first device 120 has user rights to the first media content, and a user account authenticated on second device 130 has user rights to the second media content. In some embodiments, content list manager 630 may be configured to have and store content information (e.g., name, author, playable number, playable period, etc.) regarding media content to which each user account authenticated on each device including the one or more embodiments of, respectively, first device 120 and second device 130 has user rights in association with identification information of each of the device. Content list manager 630 may be further configured to identify the first media content to which the user account authenticated on first device 120 has user rights, based on the identification information of first device 120. Further, content list manager 630 may be configured to add the first media content into a group content list that already included the second media content, to which the user account authenticated on second device 130 included in the content sharing group has user rights, when group manager 620 adds first device 120 into the content sharing group.

In some embodiments, content list manager 630 may be configured to update the group content list that already included the second media content to thereby include the first media content, based on the received content information (e.g., name, author, playable number, playable period, etc.) regarding the first media content.

In some embodiments, content list manager 630 may be configured to update the group content list that included the first media content and the second media content to thereby exclude the first media content, when group manager 620 withdraws first device 120 from the content sharing group.

Content list manager 630 may be configured to transmit, to at least one of first device 120 and second device 130 included in the content sharing group, the group content list that includes the first media content and the second media content. In some embodiments, content list manager 630 may be configured to transmit, to second device 130, the updated group content list from which the first media content was excluded. In some embodiments, content list manager 630 may be configured to transmit, to first device 120, the updated group content list from which the second media content was excluded.

Streaming transmitter 640 may be configured to stream the second media content to first device 120 included in the content sharing group. In some embodiments, streaming transmitter 640 may be configured to stream the second media content to first device 120, based on a user input, received from first device 120, to select the second media content from the group content list. In some embodiments, streaming transmitter 640 may be configured to stream the second media content to first device 120 in parallel with streaming of the second media content to second device 130, while streaming transmitter 640 streams the second media content to second device 130. In some embodiments, streaming transmitter 640 may be configured to stream the second media content to first device 120, based on the authorization information for playing the second media content.

In some embodiments, streaming transmitter 640 may be configured to stream the first media content to second device 130 included in the content sharing group. In some embodiments, streaming transmitter 640 may be configured to stream the first media content to second device 130, based on a user input, received from second device 130, to select the first media content from the group content list. In some embodiments, streaming transmitter 640 may be configured to stream the first media content to second device 130 in parallel with streaming of the first media content to first device 120, while streaming transmitter 640 streams the first media content to first device 120.

In some embodiments, streaming transmitter 640 may be configured to stop streaming of the first media content to second device 130, when group manager 620 withdraws first device 120 from the content sharing group. Further, streaming transmitter 640 may be configured to stop streaming of the second media content to first device 120, if group manager 620 withdraws second device 130 from the content sharing group.

In some embodiments, streaming transmitter 640 may be configured to continue streaming of the first media content to second device 130 after group manager 620 withdraws first device 120 from the content sharing group. For example, but not as a limitation, when group manager 620 withdraws first device 120 from the content sharing group while streaming transmitter 640 is streaming the first media content to second device 130, streaming transmitter 640 may be configured to continue streaming of the first media content to second device 130 for a predetermined time thereafter. Thus, a user of second device 130 may seamlessly view or listen to the first media content, to which the user account authenticated on first device 120 has user rights. Further, in some embodiments, streaming transmitter 640 may be configured to continue streaming of the second media content to first device 120 after group manager 620 withdraws second device 130 from the content sharing group.

Thus, FIG. 6 shows an example server by which at least portions of a media content streaming service may be implemented, in accordance with various embodiments described herein.

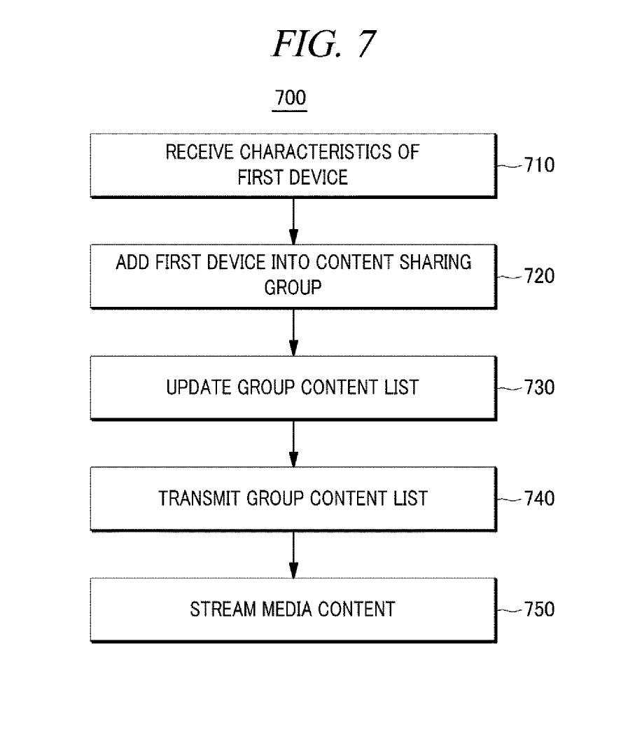

FIG. 7 shows an example processing flow 700 of operations by which at least portions of a media content streaming service may be implemented, in accordance with various embodiments described herein. The operations of processing flow 700 may be implemented in system configuration 10 including first device 120, second device 130 and server 140, as illustrated in FIG. 1. Processing flow 700 may include one or more operations, actions, or functions as illustrated by one or more blocks 710, 720, 730, 740 and/or 750. Although illustrated as discrete blocks, various blocks may be divided into additional blocks, combined into fewer blocks, or eliminated, depending on the desired implementation. Processing may begin at block 710.

Block 710 (Receive Characteristics of First Device) may refer to server 140 receiving, from first device 120, characteristics of first device 120 or a user of first device 120. For example, but not as a limitation, the characteristics of first device 120 or the user of first device 120 may include at least one of location information of first device 120, individual information regarding age or gender of the user of first device 120, identification information of first device 120 or a user input to select a content sharing group. Further, the location information of first device 120 may include at least one of location coordinates provided by a GPS sensor communicatively coupled to first device 120, base station information regarding a base station communicatively coupled to first device 120, or access point information regarding an access point communicatively coupled to first device 120. Processing may proceed from block 710 to block 720.

Block 720 (Add First Device into Content Sharing Group) may refer to server 140 adding first device 120 into a content sharing group that has at least one end device including second device 130, based on the characteristics of first device 120 and/or the user of first device 120 received at block 710. In some embodiments, at block 720, server 140 may calculate a distance between a present location of first device 120 and a present location of second device 130 included in a content sharing group, based on the location coordinates of first device 120 and second device 130. Further, server 140 may add first device 120 into the content sharing group, if the calculated distance is less than a predetermined threshold distance value stored in a memory of server 140.

In some embodiments, at block 720, server 140 may organize a content sharing group that includes first device 120 and second device 130, based on the age or gender of the user of first device 120 and that of a user of second device 130. For example, server 140 may add first device 120 into a content sharing group that has already included second device 130, if age or gender of the user of first device 120 is the same as that of the user of second device 130.

In some embodiments, at block 720, server 140 may add first device 120 into a content sharing group, based on the received user input to select the content sharing group. The user input may include a request to join the content sharing group. Processing may proceed from block 720 to block 730.

Block 730 (Update Group Content List) may refer to server 140 generating and/or updating a group content list to include first media content and second media content. A user account authenticated on first device 120 has user rights to the first media content, and a user account authenticated on second device 130 has user rights to the second media content. In some embodiments, server 140 may have and store content information (e.g., name, author, playable number, playable period, etc.) regarding media content to which each user account authenticated on each device including the one or more embodiments of, respectively, first device 120 and second device 130 has user rights in association with identification information of each device. At block 730, server 140 may identify the first media content to which the user account authenticated on first device 120 has user rights, based on the identification information of first device 120 received at block 710. Further, server 140 may add the first media content into a group content list that already included the second media content, to which the user account authenticated on second device 130 included in the content sharing group has user rights. Processing may proceed from block 730 to block 740.

Block 740 (Transmit Group Content List) may refer to server 140 transmitting, to first device 120 and second device 130 included in the content sharing group, the group content list that includes the first media content and the second media content. Processing may proceed from block 740 to block 750.

Block 750 (Stream Media Content) may refer to server 140 streaming the second media content to first device 120 included in the content sharing group. In some embodiments, at block 750, server 140 may receive, from first device 120, a user input to select the second media content from the group content list transmitted at block 740. Further, server 140 may stream the second media content to first device 120, based on the user input. In some embodiments, server 140 may stream the second media content to first device 120 in parallel with streaming of the second media content to second device 130. Further, at block 750, server 140 may receive, from second device 130, a user input to select the first media content from the group content list transmitted at block 740. Further, server 140 may stream the first media content to second device 130, based on the user input. In some embodiments, server 140 may stream the first media content to second device 130 in parallel with streaming of the first media content to first device 120.

Thus, FIG. 7 shows an example processing flow 700 of operations by which at least portions of a media content streaming service may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

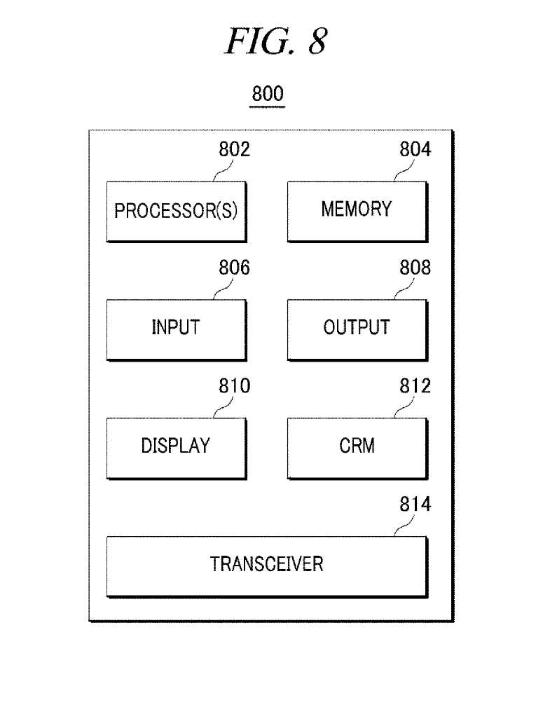

FIG. 8 shows an illustrative computing embodiment, in which any of the processes and sub-processes of a media content streaming service may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, that is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
a receiver configured to receive, from a first device having rights to use or play first media content, characteristics of the first device or a user of the first device;
a group manager configured to add the first device into a content sharing group having a second device, based on the characteristics of the first device or the user of the first device;
a content list manager configured to transmit, to the first device, a group content list that includes second media content that the second device has rights to play; and
a streaming transmitter configured to stream the second media content to the first device.

2. The server of claim 1, wherein the characteristics of the first device or the user of the first device includes at least one of location information of the first device, individual information regarding age or gender of the user of the first device, identification information of the first device, or a user input to select the content sharing group.

3. The server of claim 1,
wherein the receiver is further configured to receive, from the first device, content information regarding the first media content,
wherein the content list manager is further configured to:
update the group content list to include the first media content, based on the received content information, and
transmit the updated group content list to the second device.

4. The server of claim 2, wherein the content list manager is further configured to:
identify the first media content, based on the identification information of the first device,
update the group content list to include the identified first media content, and
transmit the updated group content list to the second device.

5. The server of claim 3, wherein the streaming transmitter is further configured to stream the first media content to the second device.

6. The server of claim 5, wherein the streaming transmitter is further configured to stop streaming of the first media content to the second device when the group manager withdraws the first device from the content sharing group.

7. The server of claim 5, wherein the streaming transmitter is further configured to continue streaming the first media content to the second device after the group manager withdraws the first device from the content sharing group.

8. The server of claim 3, wherein the content list manager is further configured to update the group content list to exclude the first media content, when the group manager withdraws the first device from the content sharing group.

9. The server of claim 3,
wherein the receiver is further configured to receive, from the first device, authorization to play the first media content, and
wherein the streaming transmitter is further configured to stream the first media content to the second device, based on the received authorization.

10. The server of claim 9, wherein the authorization includes at least one of a number of authorized plays for the first media content or an authorized period of time in which the first media content may be played.

11. The server of claim 2, wherein the location information includes at least one of location coordinates provided by a global positioning system (GPS) sensor communicatively coupled to the first device, base station information regarding a base station communicatively coupled to the first device, or access point information regarding an access point communicatively coupled to the first device.

12. The server of claim 1, wherein the streaming transmitter is further configured to stream, to the second device, the first media in parallel with streaming to the first device.

13. The server of claim 2,
wherein the receiver is further configured to receive, from the first device, authentication information associated with the content sharing group, and
wherein the group manager is configured to add the first device into the content sharing group, further based on the received authentication information.

14. A method performed under control of a server, comprising:
receiving, from a first device having rights to use or play first media content, characteristics of the first device or a user of the first device;
adding the first device into a content sharing group having a second device, based on the characteristics of the first device or the user of the first device;
transmitting, to the first device, a group content list that includes second media content that the second device has rights to play; and
streaming the second media content to the first device.

15. The method of claim 14, wherein the characteristics of the first device or the user of the first device includes at least one of location information of the first device, individual information regarding age or gender of the user of the first device, identification information of the first device or a user input to select the content sharing group.

16. The method of claim 14, further comprising:
receiving, from the first device, content information regarding the first media content;
updating the group content list to include the first media content, based on the received content information;
transmitting the updated group content list to the second device;
receiving, from the second device, a user input to select the first media content from the group content list; and
streaming the first media content to the second device, based on the received user input.

17. The method of claim 16, further comprising:
receiving, from the first device, authorization to play the first media content,
wherein the streaming of the first media content is based on the received authorization.

18. A computer-readable storage medium having thereon computer-executable instructions that, in response to execution, cause a server to perform operations, comprising:
receiving, from a first device having rights to use or play first media content, characteristics of the first device or a user of the first device;
adding the first device into a content sharing group having a second device, based on the characteristics of the first device or the user of the first device;
transmitting, to the first device, a group content list that includes second media content that the second device has rights to play; and
streaming the second media content to the first device.

19. The computer-readable storage medium of claim 18, wherein the characteristics of the first device or the user of the first device includes at least one of location information of the first device, individual information regarding age or gender of the user of the first device, identification information of the first device or a user input to select the content sharing group.

20. The computer-readable storage medium of claim 19, wherein the operations further comprise:
identifying the first media content, based on the identification information of the first device;
updating the group content list to include the identified first media content;
transmitting, to the second device, the updated group content list;
receiving, from the second device, a user input to select the first media content from the group content list; and
streaming the first media content to the second device, based on the received user input.
